(19) United States
(12) Patent Application Publication
(10) Pub. No.: US 2007/0086451 A1
(43) Pub. Date: Apr. 19, 2007

(54) Information processing apparatus and operation control method

(76) Inventors: Seiji Sato, Akishima-shi (JP); Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/521,663

(22) Filed: Sep. 15, 2006

(30) Foreign Application Priority Data
Oct. 14, 2005 (JP) 2005-300443

(51) Int. Cl. H04L 12/56

(52) U.S. Cl. 370/389

(57) ABSTRACT

According to one embodiment, an information processing apparatus includes a main body, an operation switch which is provided on the main body, a determination unit which executes, during a time period in which the main body is in a power-off state, a determination process for determining whether a timing, at which communication with an external device is to be executed, has come, a power control unit which powers on the main body in a case where the operation switch is not operated and the timing has come, and stops the execution of the determination process and keeps the main body in the power-off state in a case where the operation switch is operated before the timing comes, and a communication device which executes the communication with the external device in response to power-on of the main body.

### CROSS-REFERENCE TO RELATED APPLICATIONS

This application is based upon and claims the benefit of priority from Japanese Patent Application No. 2005-300443, filed Oct. 14, 2005, the entire contents of which are incorporated herein by reference.

### BACKGROUND

1. Field

One embodiment of the invention relates generally to an information processing apparatus such as a personal computer, and more particularly to an information processing apparatus including a communication device, and to an operation control method for use in the information processing apparatus.

2. Description of the Related Art

In recent years, various types of portable personal computers, for instance, laptop PCs or notebook PCs, have been developed. These computers are equipped with communication devices which execute communication with the outside.

The use of the communication device enables execution of transmission/reception of e-mails, access to Web sites, etc.

In usual cases, however, data communication, such as reception/transmission of e-mails, cannot be executed unless the computer is in the power-on state.

Under the circumstances, there is a demand for the advent of a novel scheme which enables automatic execution of data communication, such as reception/transmission of e-mails, by automatically powering on the computer.

Jpn. Pat. Appln. KOKAI Publication No. 2003-139874 discloses a technique which automatically starts up a microcomputer when a count value of a timer reaches a preset value.

If the function of automatically powering on the computer is always enabled, power may uselessly be consumed. The reason is that in an environment in which the communication device is not usable, data communication cannot be executed even if the computer is automatically powered on.

Normally, in order to disable the function of automatically powering on the computer, the user is required to re-set the operational environment of the computer by operating purpose-specific software for this function. Such a re-setting operation of the operational environment, however, cannot be executed unless the computer is booted up and the purpose-specific software is started.

Thus, in the case of constructing a system having the function of automatically executing data communication by powering on the computer, it is also necessary to provide a technique which can easily disable this function.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an example of the external appearance of the front side of an information processing apparatus according to an embodiment of the invention;

FIG. 2 is an exemplary perspective view showing an example of the external appearance of the information processing apparatus shown in FIG. 1 in the state in which a display unit is closed;

FIG. 3 is an exemplary block diagram showing an example of the system configuration of the information processing apparatus shown in FIG. 1;

FIG. 4 shows an example of the scheme of a system state transition in the information processing apparatus shown in FIG. 1;

FIG. 5 is an exemplary flow chart illustrating an example of the basic procedure of Auto Sync function that is executed by the information processing apparatus shown in FIG. 1;

FIG. 6 shows an example of the relationship between an OS, a utility program and a communication program, which are used in the information processing apparatus shown in FIG. 1;

FIG. 7 is an exemplary flow chart illustrating an example of the control procedure of the Auto Sync function that is executed by the information processing apparatus shown in FIG. 1;

FIG. 8 is an exemplary flow chart illustrating an example of a process procedure which is executed by an EC/KBC that is provided in the information processing apparatus shown in FIG. 1; and

FIG. 9 is an exemplary flow chart illustrating an example of a forced termination process which is executed by the EC/KBC that is provided in the information processing apparatus shown in FIG. 1.

### DETAILED DESCRIPTION

Various embodiments according to the invention will be described hereinafter with reference to the accompanying drawings. In general, according to one embodiment of the invention, an information processing apparatus includes a main body, an operation switch which is provided on the main body, a determination unit which executes, during a time period in which the main body is in a power-off state, a determination process for determining whether a timing, at which communication with an external device is to be executed, has come, a power control unit which powers on the main body in a case where the operation switch is not operated and the timing at which the communication is to be executed has come, and stops the execution of the determination process and keeps the main body in the power-off state in a case where the operation switch is operated before the timing at which the communication is to be executed comes, and a communication device which executes the communication with the external device in response to power-on of the main body.

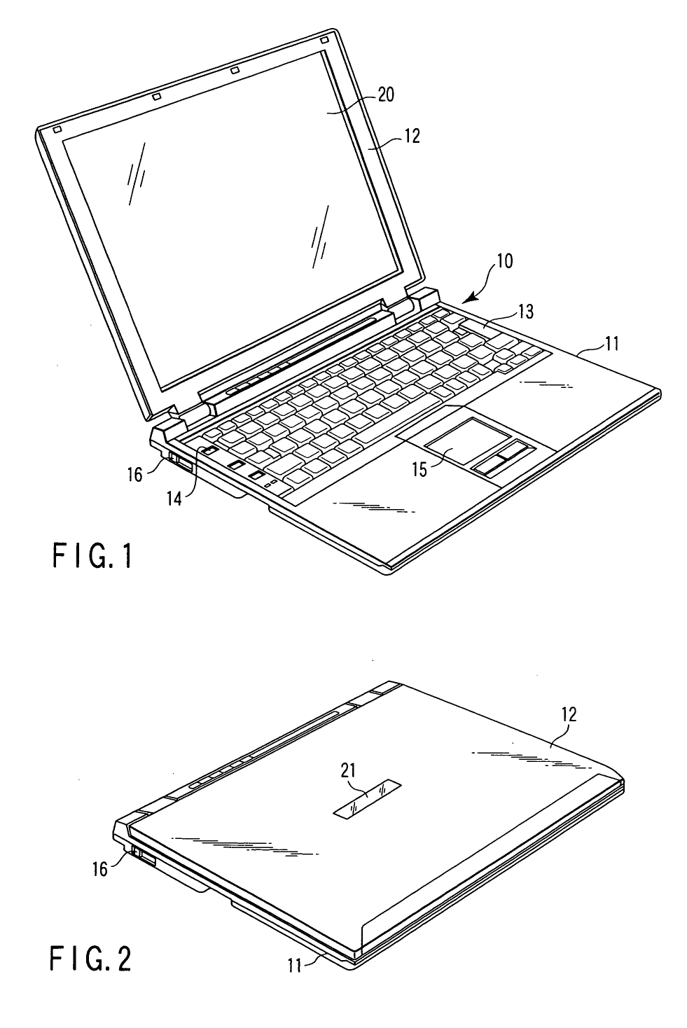

To begin with, the structure of an information processing apparatus according to an embodiment of the invention is described referring to FIG. 1 and FIG. 2. The information processing apparatus is realized, for example, as a battery-powerable notebook-type mobile personal computer 10. The computer 10 has a function of periodically powering on the computer 10, automatically executing data communication for reception of e-mails, synchronization of schedule data, etc., and powering off the computer 10 after execution of the data communication. Hereinafter, this function is referred to as “Auto Sync function”.

FIG. 1 is a perspective view showing the front side of the computer 10 in the state in which a display unit is opened.

The computer 10 comprises a computer main body 11 and a display unit 12. A display device that is composed of an LCD (Liquid Crystal Display) 20 is built in the display unit 12. The display screen of the LCD 20 is positioned at an approximately central part of the display unit 12.

The display unit 12 is supported on the computer main body 11 such that the display unit 12 is freely rotatable between an open position where the top surface of the computer main body 11 is exposed and a closed position where the top surface of the computer main body 11 is covered. The computer main body 11 has a thin box-shaped casing. A keyboard 13, a power button 14 for powering on/off the computer 10, and a touch pad 15 are disposed on the top surface of the computer main body 11. A communication device is built in the computer main body 11. In the Auto Sync function, the communication device is used to automatically execute data communication with an external device such as a mail server or another computer.

An operation switch 16 is provided on a left side surface of the computer main body 11. The operation switch 16 is a hardware switch for permitting/prohibiting execution of the Auto Sync function.

Simply by operating the operation switch 16, the user can easily disable the Auto Sync function. If the Auto Sync function is disabled, the computer main body 11 is kept in the power-off state unless and until the user operates the power button 14. If the user operates the operation switch 16 once again, the Auto Sync function is enabled.

Thus, the user can easily disable the Auto Sync function, where necessary, simply by operating the operation switch 16, without the need to re-set the operational environment of the computer 10.

A 2-state switch, such as a slide switch, is usable as the operation switch 16. In this case, the operation switch 16 is set in one of a first state which designates permission of execution of data communication by the Auto Sync function, and a second state which designates prohibition of execution of data communication by the Auto Sync function. Needless to say, the operation switch 16 may be realized by a push button switch.

Besides, a wireless communication switch may be used as the operation switch 16. The wireless communication switch is an operation switch for permitting/prohibiting execution of wireless communication. The wireless communication switch is realized by a 2-state switch such as a slide switch. The wireless communication switch is set in one of a first state which designates permission of execution of wireless communication, and a second state which designates prohibition of execution of wireless communication. In the case where the wireless communication switch is used as the operation switch 16, if the user sets the wireless communication switch in the second state (off-state), the Auto Sync function is disabled.

Either a wireless communication device or a wired communication device may be used as the above-described communication device. If the Auto Sync function is disabled, the computer 10 is kept in the power-off state unless and until the user operates the power button 14. In this case, irrespective of whether the communication device is the wireless communication device or wired communication device, data communication by the communication device is not executed.

FIG. 2 is a perspective view showing the external appearance of the computer 10 in the state in which the display unit 12 is closed. A sub-display 21 is disposed on the back surface of the display unit 12. The sub-display 21 is used to display various statuses relating to the Auto Sync function. For example, the sub-display 21 displays information indicative of an electric field intensity level of a radio signal from a base station, information indicative of reception of a new e-mail, etc. The sub-display 21 enables the user to confirm, for example, whether the current position is within a communication range, and whether an e-mail is received, even in the state in which the display unit 12 is closed.

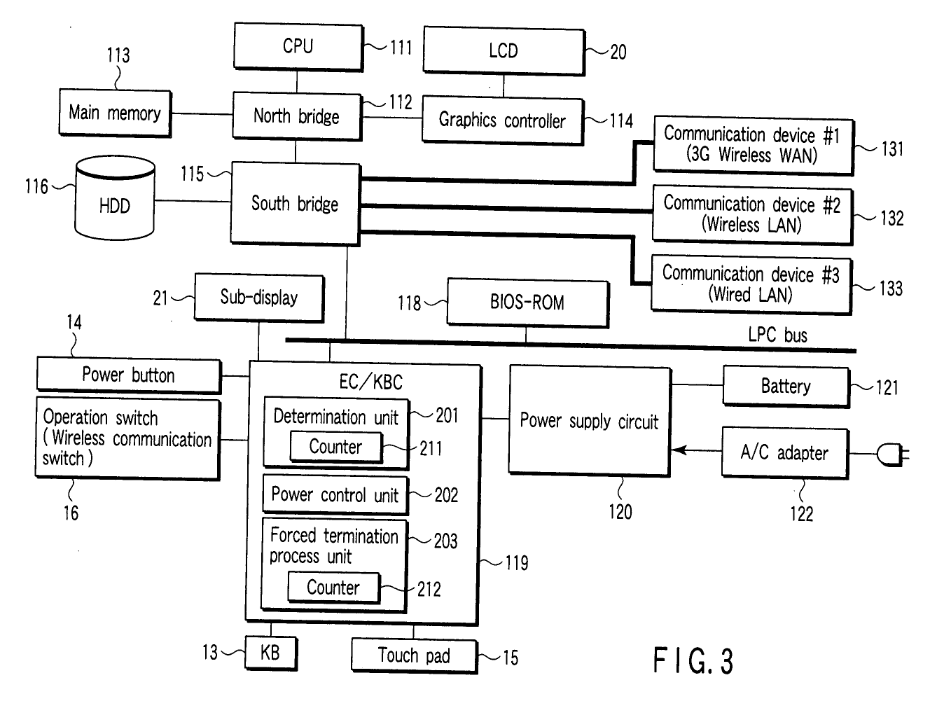

FIG. 3 is a block diagram showing an example of the system configuration of the computer 10.

The computer 10 comprises a CPU 111, a north bridge 112, a main memory 113, a graphics controller 114, a south bridge 115, a hard disk drive (HDD) 116, a flash BIOS-ROM 118, an embedded controller/keyboard controller IC (EC/KBC) 119, a power supply circuit 120, and communication devices 131 to 133.

The CPU 111 is a processor that controls the operation of the computer 10. The CPU 111 executes an operating system and various application programs/utility programs, which are loaded from the HDD 116 into the main memory 113. The CPU 111 also executes a system BIOS (Basic Input/Output System) that is stored in the flash BIOS-ROM 118. The system BIOS is a program for hardware control.

The north bridge 112 is a bridge device that connects a local bus of the CPU 111 and the south bridge 115. The north bridge 112, has a function of executing communication with the graphics controller 114 via, e.g. an AGP (Accelerated Graphics Port) bus. The north bridge 112 includes a memory controller that controls the main memory 115.

The graphics controller 114 is a display controller for controlling the LCD 20 that is used as a display monitor of the computer 10. The south bridge 115 is connected to a PCI (Peripheral Component Interconnect) bus and an LPC (Low Pin Count) bus. In addition, the south bridge 115 includes an IDE controller that controls the HDD 116.

The embedded controller/keyboard controller IC (EC/KBC) 119 is a 1-chip microcomputer in which an embedded controller for power management and a keyboard controller for controlling the keyboard (KB) 13 and touch pad 15 are integrated. The EC/KBC 119 has a function of cooperating with the power supply circuit 120 to power on/off the computer 10 in response to the user's operation of the power button switch 14. The power supply circuit 120 generates operation power, which is to be supplied to the components of the computer 10, using power from a battery 121 or external power supplied from an AC adapter 122. Even in the power-off state of the computer 10, the EC/KBC 119 is supplied with operation power from the power supply circuit 120.

The EC/KBC 119 includes a determination unit 201, a power control unit 202 and a forced termination process unit 203 as functional modules for controlling the Auto Sync function. The determination unit 201 executes, during a time period in which the computer main body 11 is in the power-off state, a determination process for determining whether a predetermined timing at which data communication with an external device is to be executed has come. This determination process is executed using a counter 211 (hereinafter referred to as “first counter (#1)”) that counts an elapsed time from the power-off of the computer main body 11. Specifically, responding to the power-off of the computer main body 11, the first counter (#1) 211 executes a counting operation in order to count an elapsed time from the power-off of the computer main body 11. When the count value in the counter 211 reaches a preset value, that is, when a pre-scheduled time has passed since the power-off of the computer main body 11, the determination unit 201 determines that the timing at which data communication with the external device is to be executed has come.

If the timing at which data communication is to be executed has come without the user's operation of the operation switch 16, the power control unit 202 powers on the computer main body 11.

On the other hand, if the operation switch 16 is operated by the user before the timing at which data communication with the external device is to be executed comes, the power control unit 202 suspends the execution of the determination process by the determination unit 201, thereby keeping the computer main body 11 in the power-off state. The suspension of the execution of the determination process is realized, for example, by stopping the counting operation of the first counter (#1) 211.

The forced termination process unit 203 forcibly powers off the computer main body 11, in a case where failure occurs in software (OS, application program, utility program) that executes data communication for the Auto Sync function and, as a result, a power-off request is not sent from the software before a predetermined time (fail-safe time) has passed since power-on of the computer main body 11, that is, the computer main body 11 is not powered off before the predetermined time (fail-safe time) has passed since power-on of the computer main body 11. The process of forcibly powering off is performed after the fail-safe time has passed since power-on of the computer main body 11. The forced termination process unit 203 uses a second counter (#2) 212 and determines whether an elapsed time from the power-on of the computer main body 11 reaches the fail-safe time.

The communication devices 131 to 133 are connected to the south bridge 115 via serial buses (e.g. USB or PCI EXPRESS).

The communication device 131 is a wireless communication device, which executes wireless communication with a base station according to a wireless communication standard such as 3G Wireless WAN. 3G Wireless WAN is a wide area wireless network such as a mobile phone network. The communication device 132 is also a wireless communication device, which executes wireless communication with a base station (access point) according to a wireless communication standard such as Wireless LAN. The communication device 133 is a wired communication device. The communication device 133 executes communication with an external device via a wired LAN.

Even when the computer 10 is in the power-off state, the communication devices 131 to 133 are supplied with operation power from the power supply circuit 120. When the computer 10 is in the power-off state, each of the communication devices 131 to 134 operates in a low-power state. One of the communication devices 131 to 133 is preselected as a communication device that is used for the Auto Sync function.

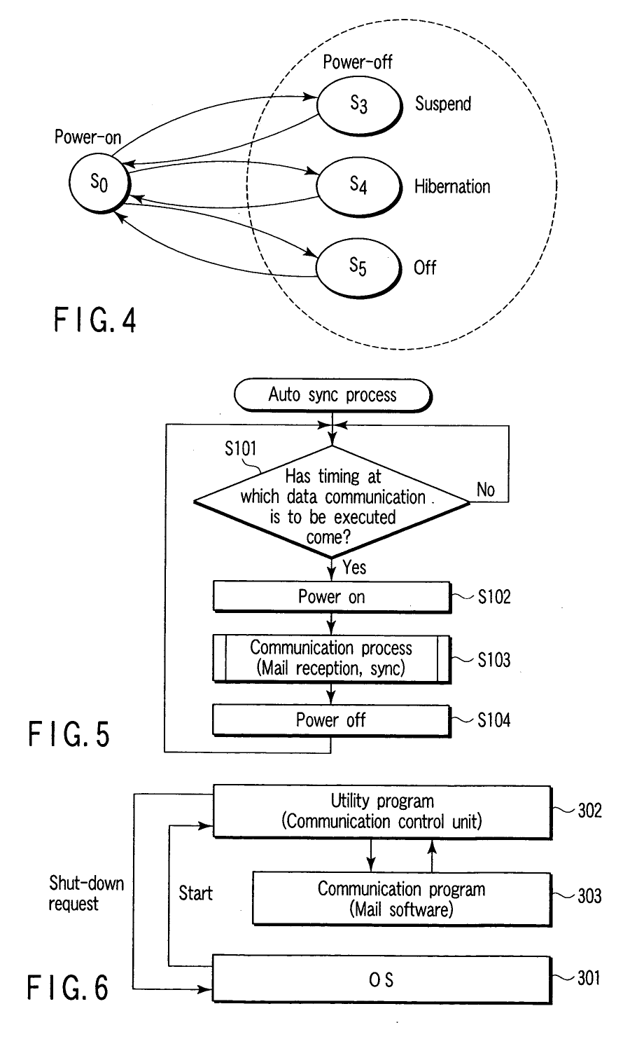

FIG. 4 shows a scheme of a system state transition in the computer 10. The computer 10 supports four system states S0, S3, S4 and S5. S0 is an operation state (working state) in which the computer 10 is powered on. S3 (suspend), S4 (hibernation) and S5 (off) are power-saving states in which the computer 10 is powered off.

In each of the system states S3, S4 and S5, the EC/KBC 119 and communication devices 131 to 133 are supplied with operation power.

The Auto Sync function can be used no matter which of the system states S3, S4 and S5 the computer 10 is in. Basically, at every timing at which the data communication is to be executed, the system state of the computer 10 makes a transition from one of S3, S4 and S5 to S0. After data communication is executed in system state S0, the system state of the computer 10 is restored from S0 to S3, S4 or S5. Each timing, at which the data communication is to be executed, is prescheduled.

Next, referring to a flow chart of FIG. 5, the basic procedure of the Auto Sync process is described.

When the Auto Sync function is enabled and effective, the determination unit 201 in the EC/KBC 119 manages the timing at which the data communication is to be executed.

While the computer 10 is in the power-off state (S3, S4 or S5), the determination unit 201 of the EC/KBC 119 determines whether the timing, at which the data communication is to be executed, has come, on the basis of whether the count value of the first counter (#1) 211 has reached a preset value. If the timing, at which the data communication is to be executed, has come (YES in step S101), the power control unit 202 of the EC/KBC 119 turns on the computer main body 11 (step S102). Responding to power-on of the computer main body 11, the operating system (OS) is booted up and the communication program is started under the control of the utility program. The communication program is an application program that runs on the operating system (OS).

The communication program executes data communication for receiving e-mails, or data communication for executing a sync process of schedule data, by using one of the communication devices 131 to 133 (step S103). After the completion of execution of the data communication, the operating system (OS) is automatically shut down by the utility program. The operating system (OS) or BIOS sends to the EC/KBC 119 a power-off request that instructs power-off of the computer main body 11. Upon receiving the power-off request, the power control unit 202 of the EC/KBC 119 powers off the computer main body 11 (step S104).

The process of steps S101 to S104 is repeatedly executed while the computer 10 is in the power-off state.

Next, referring to FIG. 6, the relationship between the operating system (OS), utility program and communication program is explained.

A utility program 302 is a terminate-and-stay-resident program. When OS 301 is booted up, the utility program 302 is first executed by the OS 301. The utility program 302 starts a communication program 303 and causes the communication program 303 to execute data communication with the external device. If the execution of the data communication process by the communication program 303 is completed, the utility program 302 issues a shut-down request to the OS 301, and shuts down the OS 301. When the shut-down process is completed, the OS 301 transmits a power-off request to the EC/KBC 119, for example, via the BIOS. The transmission of the power-off request to the EC/KBC 119 may be executed by the utility program 302.

As has been described above, the OS 301, utility program 302 and communication program 303 function as a communication control unit that executes data communication with the external device when the computer 10 is powered on, and transmits the power-off request to the EC/KBC 119 after the execution of the data communication. Since the OS 301, utility program 302 and communication program 303 are executed by the CPU 111, the CPU 111 functions as hardware corresponding to the communication control unit.

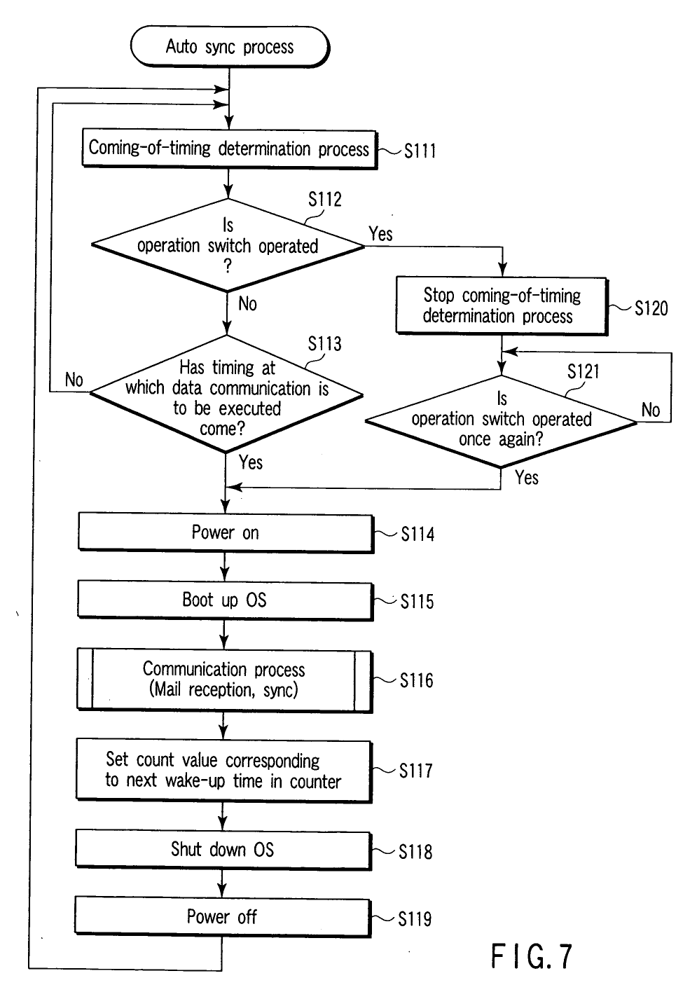

Next, referring to a flow chart of FIG. 7, the control procedure of the Auto Sync process, which is used in the present embodiment, is described.

As has been described with reference to FIG. 5, when the Auto Sync function is effective, the computer 10 is basically periodically powered on. Actually, however, depending on the state of the communication device, the data communication may not be executed even if the computer 10 is powered on. In addition, depending on where the computer 10 is in use, the user may desire to temporarily prohibit the execution of the data communication.

Taking the above into account, in the present embodiment, when the operation switch 16 is operated, a control is executed to stop the process of determining whether the timing at which the data communication is to be executed has come, thereby disabling the Auto Sync function. A specific process procedure will be described below.

While the computer 10 is in the power-off state (S3, S4 or S5), the determination unit 201 of the EC/KBC 119 performs the determination process (coming-of-timing determination process) for determining whether the timing (time instant) at which the data communication is to be executed has come, on the basis of whether the count value of the first counter (#1) 211 reaches a preset value (step S111).

If the operation switch 16 is not operated by the user and the timing (time instant) at which the data communication is to be executed has come, that is, if the timing (time instant) at which the data communication is to be executed has come in the state in which the operation switch 16 is kept in the ON state (YES in step S113), the power control unit 202 of the EC/KBC 119 powers on the computer main body 11 (step S114). Responding to the power-on of the computer main body 11, the system BIOS is executed by the CPU 111. The system BIOS executes the process for booting up the operating system (OS) 301 (step S115). If the operating system (OS) 301 is booted up, the communication program 303 is started under the control of the utility program 302. Using the communication device, the communication program 303 executes data communication for receiving e-mails or data communication for the sync process of schedule data (step S116). If the execution of the data communication is completed, the utility program 302 sets a count value, which corresponds to a wake-up time indicative of the timing when data communication is to be next executed, in the first counter (#1) 211 in the EC/KBC 119 (step S117), and sends a shut-down request to the OS 301, thereby shutting down the OS 301 (step S118).

The OS 301 or BIOS sends to the EC/KBC 119 a power-off request to instruct powering-off of the computer main body 11. Upon receiving the power-off request, the power control unit 202 of the EC/KBC 119 powers off the computer main body 11 (step S119). In the meantime, the OS 301 or BIOS may execute the process for setting the count value, which corresponds to the wake-up time, in the first counter (#1) 211 in the EC/KBC 119.

If the operation switch 16 is operated by the user before the timing at which the data communication is to be executed has come, that is, if the operation switch 16 is turned off by the user before the timing at which the data communication is to be executed has come (YES in step S112), the EC/KBC 119 stops the execution of the coming-of-timing determination process at this time point, and keeps the computer main body 11 in the power-off state (step S120). Thus, the execution of the Auto Sync process is temporarily stopped.

If the operation switch 16 is operated once again by the user in this state, that is, if the operation switch 16 is turned on by the user (YES in step S121), the EC/KBC 119 immediately powers on the computer main body 11 (step S114). Thereby, the Auto Sync function is enabled once again, and the process of steps S115 to S119 is executed.

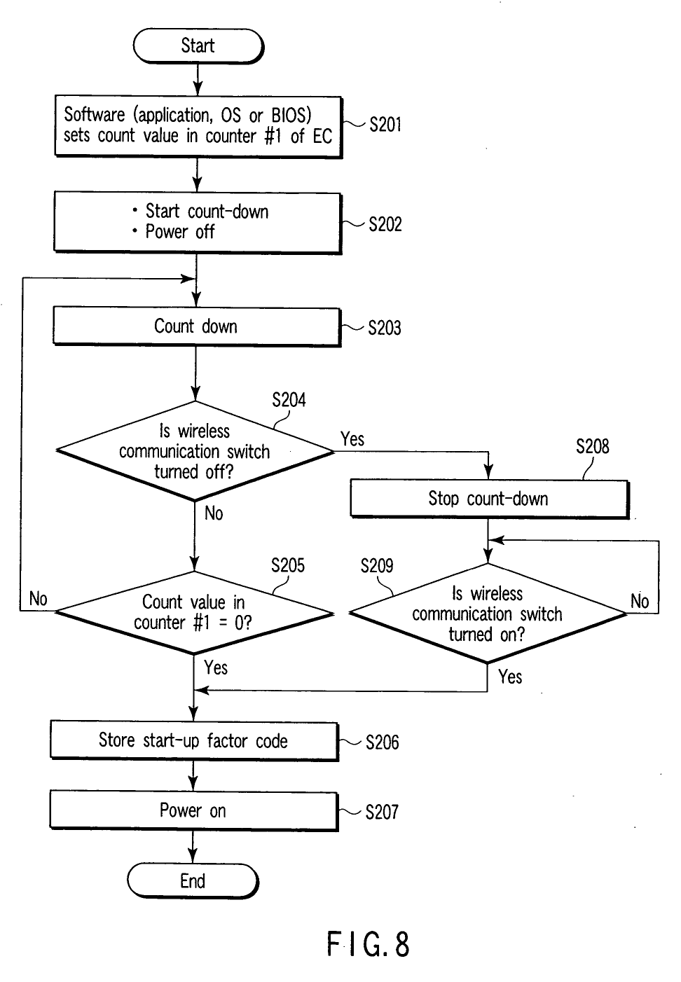

Next, referring to a flow chart of FIG. 8, a description is given of a specific procedure of the Auto Sync function control process, which is executed by the EC/KBC 119.

In the flow chart of FIG. 8, it is assumed that the first counter (#1) 211 is a down-counter. In this case, the first counter (#1) 211 executes a count operation (count-down operation) of decrementing the count value, which is set in the first counter (#1) 211, in units of 1. In addition, in the flow chart of FIG. 8, it is assumed that the above-described wireless communication switch is used as the operation switch 16.

The software (utility program 302, application program such as communication program 303, or OS 301 or BIOS) sets in the first counter (#1) 211 a count value which corresponds to a wake-up time indicative of the timing when data communication is to be next executed (for instance, a count value designating a time interval from the power-off of the computer main body 11 to the next power-on of the computer main body 11), and the software sends a power-off request to the EC/KBC 119 (step S201).

Upon receiving the power-off request, the EC/KBC 119 powers off the computer main body 11 and causes the first counter (#1) 211 to start the count-down operation (step S202). The first counter (#1) 211 executes the count-down operation and decrements the set count value in units of 1 in every predetermined unit time.

The EC/KBC 119 determines whether the wireless communication switch is turned off by the user (step S204). If the wireless communication switch is not turned off by the user (NO in step S204), the EC/KBC 119 determines whether the count value that is output from the first counter (#1) 211 reaches a preset value (e.g. 0), thereby determine whether the timing, at which the data communication is to be executed, has come (step S205).

If the wireless communication switch is not turned off by the user and the count value that is output from the first counter (#1) 211 reaches the preset value (e.g. 0) (YES in step S205), the EC/KBC 119 stores a start-up factor code which indicates that the power-on is effected for the Auto Sync process (step S206), and powers on the computer main body 11 (step S207).

If the computer main body 11 is powered on, the BIOS checks the start-up factor code and determines whether the power-on is effected for the Auto Sync process or some other purpose. If the power-on is effected for the Auto Sync process, the data communication process is automatically executed under the control of the BIOS, OS 301 or utility program 302.

If the wireless communication switch is turned off by the user before the count value that is output from the first counter (#1) 211 reaches the preset value (e.g. 0) (YES in step S204), the EC/KBC 119 immediately stops the count-down operation of the first counter (#1) 211 and temporarily disables the Auto Sync function (step S208). Thereafter, if the wireless communication switch is turned on by the user (YES in step S209), the EC/KBC 119 executes the process of steps S206 and S207.

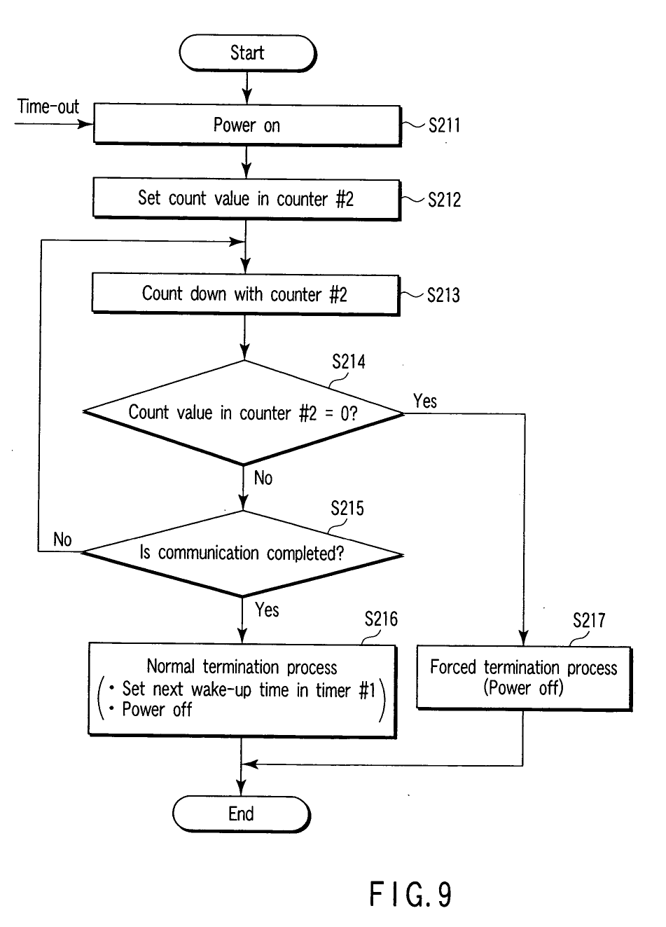

Next, with reference to a flow chart of FIG. 9, the forced termination process, which is executed by the EC/KBC 119, is described.

When the count value that is output from the first counter (#1) 211 reaches the preset value (e.g. 0) (time-out), the EC/KBC 119 powers on the computer main body 11 (step S211) and sets in the second counter (#2) 212 a predetermined count value corresponding to a fail-safe time (step S212). The second counter (#2) 212 executes a count-down operation and decrements the set count value in units of 1 (step S214).

If the communication process by the software is completed and a power-off request is received from the software before the count value that is output from the second counter (#2) 212 reaches the predetermined value (e.g. 0) (YES in step S215), the EC/KBC 119 executes a normal termination process for powering off the computer 11 in response to the received power-off request (step S216). In the normal termination process, a process is also executed, which sets in the first counter (#1) 211 a count value corresponding to the next wakeup time, which is sent from the software.

On the other hand, if the count value that is output from the second counter (#2) 212 reaches the predetermined value (e.g. 0) before the communication process by the software is completed, that is, if the count value that is output from the second counter (#2) 212 reaches the predetermined value (e.g. 0) before the power-off request is received from the software, the EC/KBC 119 determines that an error has occurred in the software, and executes the forced termination process for forcibly powering off the computer 11 (step S217). If the computer 11 is kept in the power-on state due to malfunction (hang-up or endless loop) of the software, such a problem occurs that the residual battery capacity is considerably decreased. The forced termination process prevents the occurrence of such a problem.

As has been described above, in the computer 10 of the present embodiment, if the operation switch 16 is operated, the determination process for determining whether the timing, at which the data communication is to be executed, has come is stopped. Thus, the user can disable the Auto Sync function simply by operating the operation switch 16, without the need to re-set the operational environment of the computer 10.

In the present embodiment, the counters 211 and 212 are realized by down-counters. Alternatively, the counters 211 and 212 may be realized by up-counters.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus comprising:
a communication module configured for integration within an information processing apparatus, the module further configured to communicate with a device external to the information processing apparatus;
a controller configured to enable the module to automatically communicate with the external device; and
a manually operable switch configured to permit manual override of automatic enablement of communication by the controller.

2. The communication apparatus according to claim 1, wherein the controller enables automatic communication when a predetermined condition is satisfied.

3. The communication apparatus according to claim 1, wherein the controller is configured to automatically power-off the information processing apparatus after the communication module has executed the communication.

4. The communication apparatus according to claim 1, further comprising a counter embedded in the controller, the counter configured to determine whether a current time coincides with a preset time, and wherein the controller interfaces with the counter such that said controller can enable automatic communication with the external device when the current time coincides with the preset time.

5. The communication apparatus according to claim 1, wherein the communication module is configured to provide wireless communication.

6. The communication apparatus according to claim 1, further comprising the information processing apparatus, the information processing apparatus comprising a housing, wherein said communication apparatus is integrated into the information processing apparatus and wherein the switch is mounted on the housing.

7. An information processing apparatus comprising:
a housing;
a communication module within the housing and configured to communicate with an external device; and
a controller configured to execute automatic power-on for enabling the automatic communication module to communicate with the external device;
a switch configured to be manually operated so as to control the controller, wherein in one position, the switch enables the controller to permit automatic power-on of the apparatus and in another position, the switch disables the controller to prevent automatic power-on of the apparatus.

8. The information processing apparatus according to claim 7, wherein the controller is configured to permit an automatic power-on of the apparatus when a predetermined condition is satisfied.

9. The information processing apparatus according to claim 8, wherein the controller is configured to automatically power-off after the communication module has executed automatic communication.

10. The information processing apparatus according to claim 7, wherein the switch is positioned on the housing.

11. The information processing apparatus according to claim 7, further comprising a counter configured to determine whether a current time coincides with a preset time, and wherein the controller interfaces with the counter such that said controller can automatic power-on the apparatus and enable automatic communication with the external device when the current time coincides with the preset time.

12. The information processing apparatus according to claim 11, wherein the controller is configured to automatically power-off after automatic communication has occurred.

13. The information processing apparatus according to claim 7, wherein the communication module is configured to provide wireless communication.

14. A method for communicating data applied to an information processing apparatus, the method comprising:
enabling automatic communication between the information processing apparatus and an external device upon a certain condition;
configuring a switch mounted on the apparatus so that it can be manually positioned to a first state;
preventing automatic communication with the external device when the switch is in the first state.

15. The method according to claim 14, further comprising permitting automatic communication with the external device when the switch is in a second state.

16. The method according to claim 15, further comprising powering off the apparatus after automatic communication has occurred.

17. The method according to claim 14, further comprising determining whether a current time coincides with a preset time and permitting automatic communication with the external device when the switch is in a second state and when the current time coincides with the preset time.
